(19) United States
(12) Patent Application Publication
(10) Pub. No.: US 2026/0141255 A1
(43) Pub. Date: May 21, 2026

(54) REAL-TIME DATA ORCHESTRATION ENGINE

(71) Applicant: George William Bickerstaff, III, Greenwich, CT (US)

(72) Inventor: George William Bickerstaff, III, Greenwich, CT (US)

(21) Appl. No.: 19/408,493

(22) Filed: Dec. 4, 2025

(51) Int. Cl. G06N 3/092; G06F 18/21; G06N 7/01

(52) U.S. Cl. CPC G06N 3/092; G06F 18/217; G06N 7/01

(57) ABSTRACT

A real-time data orchestration engine ingests heterogeneous data streams, resolves semantic inconsistencies prior to execution using weighted graph arbitration, schedules tasks adaptively using reinforcement learning, validates outputs against semantic constraints, securely transmits results, and immutably records execution events to provide low-latency, synchronization across distributed environments.

### CROSS-REFERENCE TO RELATED APPLICATIONS

None.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

None.

### STATEMENT REGARDING PRIOR DISCLOSURES BY THE INVENTOR OR A JOINT INVENTOR

None.

### BACKGROUND OF THE INVENTION

### (1) Field of the Invention

The present invention relates generally to distributed computing systems, real-time data synchronization, and adaptive execution control. More specifically, the invention concerns methods, systems, and non-transitory computer-readable media for orchestrating heterogeneous, high-velocity data streams across distributed computing environments using semantic divergence detection, graph-based conflict arbitration, adaptive scheduling, and cryptographically verifiable audit logging.

The invention is particularly applicable to environments in which multiple independent data sources generate concurrent, asynchronous updates, where latency, inconsistency, semantic drift, or race conditions materially degrade system reliability and decision accuracy. Representative applications include financial analytics platforms, operational risk systems, regulatory and compliance monitoring, sensor-driven automation, healthcare data pipelines, and real-time decision and control systems.

### (2) Description of the Related Art

Conventional data synchronization systems typically rely on batch ingestion, periodic reconciliation, or fixed polling intervals. These techniques introduce inherent latency and fail to preserve a consistent system state when updates arrive concurrently or at high frequency.

Existing data pipelines often assume rigid, predefined schemas. When data formats evolve or originate from unstructured or semi-structured sources, such pipelines break, silently degrade, or produce partial outputs requiring manual remediation.

Traditional task schedulers generally employ static priority rules or heuristic-based queues that do not adapt to dynamic workloads, task urgency, or infrastructure constraints. Under variable conditions, these schedulers misallocate compute resources and introduce cascading bottlenecks.

Furthermore, conventional audit and logging mechanisms are frequently mutable, centralized, or opaque, rendering them unsuitable for regulatory, compliance, or forensic contexts that require tamper-evident provenance and verifiable execution history.

### BRIEF SUMMARY OF THE INVENTION

The present invention overcomes the limitations of the prior art by providing a unified real-time data orchestration engine that integrates semantic analysis, deterministic conflict resolution, adaptive scheduling, and immutable auditability into a single coherent system.

In accordance with the invention, heterogeneous data streams are continuously ingested through secure interfaces, normalized into a unified internal representation, and transformed into semantic embeddings. These embeddings are evaluated for semantic divergence and arbitrated using a weighted directed acyclic graph to resolve conflicting updates prior to execution.

Processing tasks are scheduled using an adaptive reinforcement-learning scheduler responsive to real-time system telemetry, task urgency, and resource availability. Orchestrated outputs are validated against rule-based and semantic constraints, securely transmitted, and immutably recorded using cryptographically verifiable ledger logging.

The invention thereby provides low-latency, self-adapting orchestration while maintaining a consistent, explainable, and auditable system state across distributed environments.

### BRIEF DESCRIPTION OF THE SEVERAL VIEWS OF THE DRAWINGS

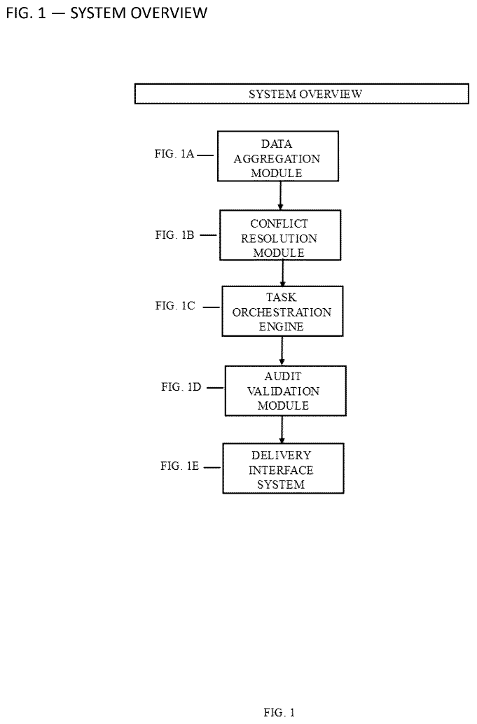

### FIG. 1—System Architecture Overview

FIG. 1 illustrates the overall system architecture of the real-time data orchestration engine, depicting the complete end-to-end lifecycle of data as it flows from ingestion through conflict resolution, task orchestration, audit validation, and delivery.

The figure establishes the logical ordering and dependency relationships among the major subsystems, showing how semantic evaluation precedes execution and how audit validation precedes delivery.

FIG. 1 serves as a master reference diagram for understanding how each subsequent drawing integrates into the unified orchestration pipeline.

### FIG. 1A—DATA AGGREGATION MODULE

FIG. 1A illustrates the Data Aggregation Module, which functions as the secure ingress point for all external data sources.

The module buffers, validates, and normalizes incoming data while isolating upstream volatility from downstream processing.

By decoupling ingestion from execution, the module prevents external variability from destabilizing system operation.

### FIG. 1B—Conflict Resolution Module

FIG. 1B illustrates the Conflict Resolution Module, which evaluates concurrent updates for semantic inconsistency rather than syntactic mismatch.

The module resolves contradictions deterministically using graph-based arbitration prior to execution.

This prevents race conditions, rollback complexity, and post-hoc reconciliation.

### FIG. 1C—Task Orchestration Engine

FIG. 1C illustrates the Task Orchestration Engine responsible for execution order, resource allocation, and distributed deployment.

The engine adapts dynamically to processor load, queue depth, and task urgency.

This component converts semantic resolution outcomes into executable plans.

### FIG. 1D—Audit Validation Module

FIG. 1D illustrates the Audit Validation Module, which performs integrity, consistency, and compliance checks.

Validation occurs before permanent recordation and delivery.

This establishes a defensible audit boundary.

### FIG. 1E—Delivery Interface System

FIG. 1E illustrates the Delivery Interface System used to transmit orchestrated outputs.

The system supports secure APIs and human-readable interfaces.

Provenance and traceability are preserved during delivery.

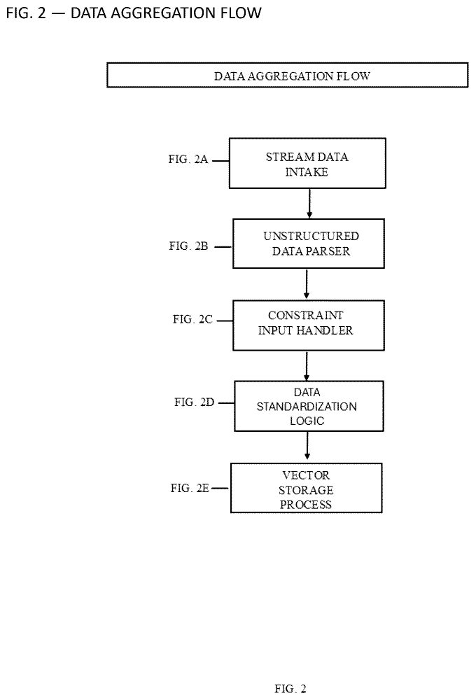

### FIG. 2—Data Aggregation Flow

FIG. 2 illustrates the internal flow of data through the aggregation module.

The flow emphasizes non-blocking, streaming ingestion.

Data is prepared consistently for semantic analysis.

### FIGS. 2A-2E—Data Aggregation Subcomponents

FIG. 2A illustrates Stream Data Intake establishing encrypted connections.

FIG. 2B illustrates Unstructured Data Parsing using semantic models.

FIG. 2C illustrates Constraint Input Handling.

FIG. 2D illustrates Data Standardization Logic.

FIG. 2E illustrates Vector Storage using lock-free concurrency.

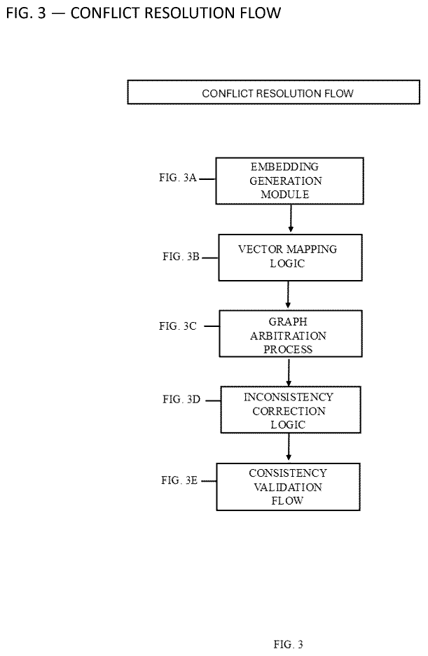

### FIG. 3—Conflict Resolution Flow

FIG. 3 illustrates semantic inconsistency detection and resolution.

Embeddings are compared prior to execution.

A single consistent system state is produced.

### FIGS. 3A-3E—Conflict Resolution Subcomponents

FIG. 3A illustrates Embedding Generation.

FIG. 3B illustrates Vector Mapping.

FIG. 3C illustrates Graph Arbitration.

FIG. 3D illustrates Inconsistency Correction.

FIG. 3E illustrates Consistency Validation.

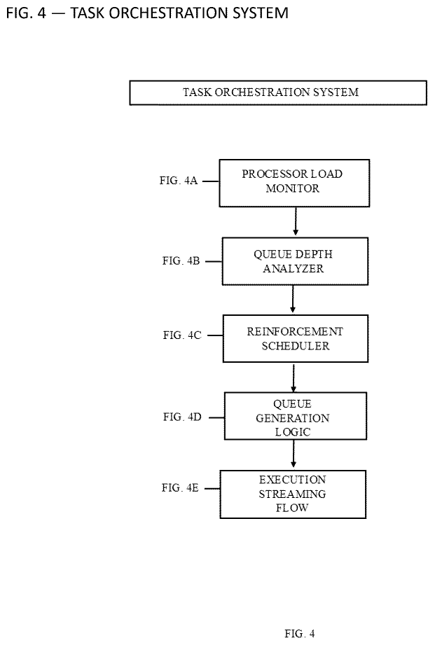

### FIG. 4—Task Orchestration System

FIG. 4 illustrates scheduling and execution control.

Resource constraints and dependencies are respected.

Continuous low-latency execution is achieved.

### FIGS. 4A-4E—Task Orchestration Subcomponents

FIG. 4A illustrates Processor Load Monitoring.

FIG. 4B illustrates Queue Depth Analysis.

FIG. 4C illustrates Reinforcement-Learning Scheduling.

FIG. 4D illustrates Queue Generation.

FIG. 4E illustrates Execution Streaming.

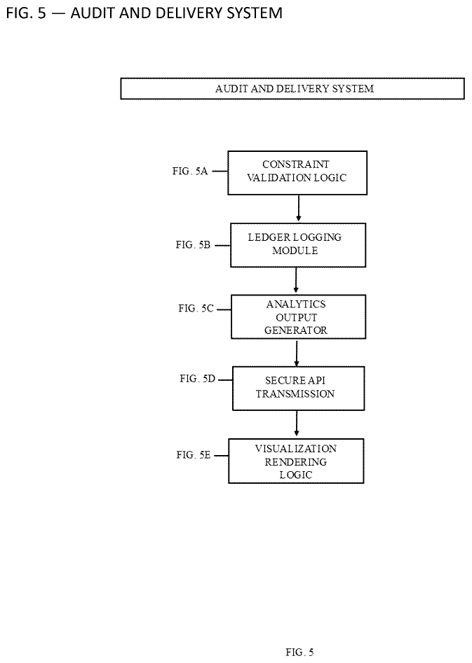

### FIG. 5—Audit and Delivery System

FIG. 5 illustrates final validation, audit logging, and delivery.

Transparency and traceability are enforced.

Compliance-ready outputs are produced.

### FIGS. 5A-5E—Audit and Delivery Subcomponents

FIG. 5A illustrates Constraint Validation.

FIG. 5B illustrates Ledger Logging.

FIG. 5C illustrates Analytics Output Generation.

FIG. 5D illustrates Secure API Transmission.

FIG. 5E illustrates Visualization Rendering.

### DETAILED DESCRIPTION OF THE INVENTION

The invention operates as a real-time semantic control plane for distributed data execution. Unlike batch reconciliation systems, semantic divergence is resolved prior to execution, preventing inconsistency from propagating.

Each subsystem addresses a specific failure mode: ingestion volatility, semantic conflict, execution contention, compliance risk, and audit opacity.

The combination of semantic embeddings, graph arbitration, adaptive scheduling, and immutable audit logging yields a deterministic, explainable, and self-optimizing system.

Data Aggregation Flow establishes encrypted intake, buffering, parsing, constraint filtering, standardization, and vector storage.

Conflict Resolution Flow generates embeddings, computes divergence, arbitrates updates using a weighted directed acyclic graph, corrects inconsistencies, and validates results.

Task Orchestration monitors telemetry, applies reinforcement learning or fallback scheduling, generates execution queues, and streams tasks.

Audit and Delivery validates outputs, records cryptographic audit trails, transmits securely, and renders visual dashboards.

1. A computer-implemented method for real-time data orchestration comprising:
(a) collecting heterogeneous data streams through encrypted interfaces;
(b) generating semantic embeddings from the data streams and storing the embeddings in a vector database;
(c) detecting and resolving semantic inconsistencies among the data streams using a weighted directed acyclic graph prior to task execution;
(d) scheduling processing tasks using an adaptive reinforcement-learning model responsive to system telemetry;
(e) validating synchronized outputs using rule-based constraints and semantic consistency checks;
(f) transmitting validated outputs through secure interfaces; and
(g) recording system actions using cryptographic ledger logging to provide a tamper-evident execution record.
(iv) schedule processing tasks using an adaptive reinforcement-learning model;
(v) validate outputs using rule-based and semantic constraints;
(vi) transmit validated outputs through secure interfaces; and
(vii) record system actions using cryptographic ledger logging.

3. A non-transitory computer-readable medium storing instructions that, when executed by one or more processors, cause the one or more processors to perform the method of claim 1.

4. The method of claim 1, wherein the reinforcement learning model comprises Q-Learning, Deep Q-Networks, SARSA, or Expected SARSA.

5. The method of claim 1, wherein task scheduling is optimized using a reward function r=τ·u. where τ represents task throughput and u represents processor utilization.

6. The method of claim 1, wherein update priority within the directed acyclic graph is defined as p=t·s, where t represents time since a last update and s represents a trust score.

7. The method of claim 1, wherein semantic embeddings are generated using transformer-based models trained to capture contextual meaning across heterogeneous data formats.

8. The method of claim 1, wherein resolving semantic inconsistencies comprises merging, overwriting, or rejecting conflicting updates based on graph arbitration outcomes.

9. The method of claim 1, wherein the vector database supports lock-free or optimistic concurrency control.

10. The method of claim 1, wherein cryptographic ledger logging comprises a permissioned blockchain or an append-only hash-chained log.

11. The system of claim 2, wherein the adaptive scheduling dynamically adjusts policies based on processor load, queue depth, and task urgency.

12. The system of claim 2, wherein validation comprises applying regulatory business, or domain-specific compliance rules.

13. The system of claim 2, wherein secure transmission comprises encrypted API communication.

14. The computer-readable medium of claim 3, wherein the instructions further generate analytics describing throughout latency, and resource utilization.
